(19) United States
(12) Patent Application Publication
(10) Pub. No.: US 2012/0097898 A1
(43) Pub. Date: Apr. 26, 2012

(54) REPLACING AQUEOUS WITH NON-AQUEOUS SOLVENT

(75) Inventors: Venkataramanan Seshadri, Pittsburgh, PA (US); Edward Yang, Falls Church, VA (US)

(73) Assignee: Plextronices, Inc.

(21) Appl. No.: 13/265,523

(22) PCT Filed: Apr. 30, 2010
(86) PCT No.: PCT/US10/33180

§ 371 Date: Jan. 3, 2012

Related U.S. Application Data
(62) Division of application No. 61/174,828, filed on May 1, 2009.

(51) Int. Cl. H01B 1/00; C08K 5/06; C08K 5/41; C08K 5/20; C08L 41/00; C08K 5/3415

(52) U.S. Cl. 252/500; 524/547; 524/104; 524/173; 524/233; 524/377

(57) ABSTRACT

Disclosed are methods of dispersing sulfonated polythiophenes in a non-aqueous solvent including replacing water for organic solvent without precipitation of the polythiophene. Once dispersed in a non-aqueous solvent, the sulfonated polythiophene can be mixed with a matrix polymer. The materials can be used in organic electronic devices including OLEDs and OPVs. The solvent processes can improve the viscosity properties. Sulfonated regioregular polythiophenes can be used. A benefit is improved solvent compatibility in building organic electronic devices and improved ability to formulate with matrix materials.

### RELATED APPLICATIONS

This application claims priority to U.S. provisional application Ser. No. 61/174,828 filed May 1, 2009, which is hereby incorporated by reference in its entirety.

### BACKGROUND

The hole injection layer (“HIL”), hole collection layer (“HCL”), or hole transport layer (“HTL”) of an organic electronic device such as an organic light-emitting diode (“OLED”) or an organic photovoltaic device (“OPV”) can desirably be highly transparent and have appropriate conductivity, e.g., conductivity that precludes pixel cross-talk during operation of the OLED. These types of layers can comprise conjugated or conducting polymers. In fabricating an HCL, HIL, or HTL including conducting polymers, a matrix polymer can be used. If the conducting polymer is dispersed in water, the choice of the matrix polymer may be restricted to highly-polar polymers, i.e. polymers including polar functional groups such as —OH, —SO₃H, etc. Because polar functional groups in matrix polymers can have undesirable effects, e.g., on light output as well as voltage stability of OLEDs, it may be beneficial to fabricate HILs, HCLs, and HTLs from conducting polymers dispersed in organic solvents, facilitating the use of matrix polymers devoid of polar functional groups, and thereby potentially improving the lifetime of the OLED, as well as other parameters and organic electronic devices including OPV.

### SUMMARY

Provided herein are methods of making compositions and devices, compositions and devices, and methods of using compositions and devices. For example, one embodiment provides a method of dispersing sulfonated polythiophenes in a non-aqueous solvent.

In particular, one embodiment provides a method comprising: i) providing at least one sulfonated polythiophene in an aqueous dispersion, ii) adding a non-aqueous solvent to the dispersion to provide a mixture, wherein the sulfonated polythiophene remains dispersed in the mixture, and iii) removing water from the mixture. Also, a composition can be prepared by methods comprising this method.

Another embodiment provides a method comprising: i) providing at least one sulfonated regioregular polythiophene in an aqueous dispersion; and ii) adding a non-aqueous solvent to the dispersion to provide a mixture, wherein the polythiophene remains dispersed in the mixture; iii) removing water from the mixture. Also, a composition can be prepared by methods comprising this method.

Another embodiment provides a method comprising: i) providing at least one sulfonated polythiophene in an aqueous dispersion; ii) adding a non-aqueous solvent to the dispersion to provide a mixture, wherein the sulfonated polythiophene remains dispersed in the mixture; and iii) exposing the mixture to vacuum, wherein the relative water content of the mixture increases with exposure to vacuum. Also, a composition can be prepared by methods comprising this method.

Another embodiment provides a composition prepared by a method comprising: i) providing at least one sulfonated polythiophene in an aqueous dispersion; ii) adding a non-aqueous solvent to the dispersion to provide a mixture, wherein the sulfonated polythiophene remains dispersed in the mixture; iii) removing water from the mixture to provide a non-aqueous dispersion of the at least one sulfonated polythiophene; and iv) combining the mixture with a matrix polymer to form the composition.

Another embodiment provides a composition prepared by a method comprising: i) providing at least one sulfonated regioregular polythiophene in an aqueous dispersion; ii) adding a non-aqueous solvent to the dispersion to provide a mixture, wherein the sulfonated polythiophene remains dispersed in the mixture; iii) removing water from the mixture to provide a non-aqueous dispersion of the at least one sulfonated polythiophene; and iv) combining the mixture with a matrix polymer to form the composition.

At least one advantage for at least one embodiment is improved solvent compatibility in building organic electronic devices.

At least one advantage for at least one embodiment is improved viscosity control in building organic electronic devices. For example, viscosity can be increased.

At least one additional advantage for at least one embodiment is improved device lifetime and other device parameters such as light output and/or voltage stability.

At least one additional advantage for at least one embodiment is improved use of organic soluble matrix polymers.

At least one additional advantage for at least one embodiment is improved use of matrix polymers devoid of protic functionalities, which can improve device performance.

At least one additional advantage for at least one embodiment is maintenance of doping despite a solvent switch.

Another advantage for at least one embodiment can include, for example, improved stability of dispersions.

Another advantage for at least one embodiment can include, for example, better dispersion when matrix polymer is present due to better solvent quality for both the sulfonated polymer and the matrix polymer.

### DETAILED DESCRIPTION

### Introduction

A variety of embodiments are described and relate in some embodiments to methods of dispersing sulfonated polythiophenes in a non-aqueous solvent. One skilled in the art can employ the below description in the practice of these embodiments.

All references cited herein are incorporated by reference.

### Sulfonated Polythiophenes

Conjugated polymers are known and include polythiophenes, polypyrroles, polyanilines, and the like. Polythiophenes include derivatived polythiophenes. Polythiophenes can be regioregular or non-regioregular. Polythiophenes can be homopolymers or copolymers including block copolymers and block copolymers comprising non-polythiophene segments. The substituent on the polythiophene can provide solubility and can include heteroatoms such as, for example, oxygen.

In particular, sulfonated polythiophenes in aqueous suspensions of the present application may be prepared as described in, for example, PCT Publication WO 2008/073149 to Seshadri et al. (assignee: Plextronics), which is hereby incorporated by reference in its entirety. One embodiment provides a composition comprising: a water soluble or water dispersible regioregular polythiophene comprising (i) at least one organic substituent, and (ii) at least one sulfonate substituent comprising sulfonate sulfur bonding directly to the polythiophene backbone.

A variety of organic substituents on the polythiophene can be used. For example, the polythiophene can have substituents which are polyether or alkyleneoxy. The substituent can be bonded to the polythiophene chain by oxygen and can comprise one, two, three, four, or five oxygen atoms, by way of example. In one embodiment of the present application, the sulfonated polythiophene comprises a sulfonated poly(3-(alkoxy)thiophene). In another embodiment, the sulfonated polythiophene comprises a regioregular sulfonated poly(3-(alkoxy)thiophene). In another embodiment, the sulfonated polythiophene comprises regioregular sulfonated poly(3-(methoxyethoxyethoxy)thiophene).

Methods of the present application may be used with aqueous suspensions of sulfonated polythiophene of various solid percentages. In embodiments of the present application, the aqueous dispersion can comprise about 0.1 wt. % to about 20 wt. % of the sulfonated polythiophene, or about 0.1 wt. % to about 8 wt. % of the sulfonated polythiophene, or suitably comprises about 0.25 wt. % to about 4 wt. % of the sulfonated polythiophene, or desirably comprises about 0.5 wt. % to about 1 wt. % of the sulfonated polythiophene.

In one embodiment, the compositions are substantially or totally free of PEDOT (polyethylenedioxythiophene) and PEDOT:PSS (PSS is polystyrene sulfonate). See, for example, use of these terms in U.S. Pat. No. 6,632,472. For example, the amount of PEDOT or PEDOT:PSS can be less than 1 wt. %, or less than 0.1 wt. %, or less than 0.01 wt. %.

In one embodiment, the sulfonated polythiophene is doped, and in another embodiment, it is not doped. In one embodiment, it is substantially or totally free of a polymeric dopant like PSS (polystyrene sulfonate).

In one embodiment, only one polymer is used in the aqueous dispersion. Polymer complexes comprising multiple polymers are not used.

### Non-Aqueous Solvents

Solvents and solvents for polymers are generally known. See, for example, March's Advanced Organic Chemistry, Reactions, Mechanisms, and Structure, 6^{th} Ed; see also Billmeyer, Textbook of Polymer Science, 3^{rd} Ed., 1984; Handbook of Organic Conductive Molecules and Polymers, ed. H. S. Nalwa, 1997.

Non-aqueous solvents of the present application may include non-aqueous solvents suitable for use with the sulfonated polythiophenes and the matrix polymer with which the sulfonated polythiophene is combined. In some embodiments, a solvent can form an azeotrope with water. Non-aqueous solvent is a term known in the art. See, for example, U.S. Pat. No. 7,223,357.

Suitable non-aqueous solvents can include polar, aprotic solvents such as, for example, methyl-2-pyrrolidone (“NMP”), dimethyl sulfoxide (“DMSO”), dimethylformamide (“DMF”), dimethylacetamide (DMAc), pyridine and its derivatives, N-substituted pyrroles, pyrrolidines, piperidines, morpholines including methyl, ethyl, formyl, and acetyl derivativzed.

Other examples of non-aqueous solvents include tetrahydrofuran (“THF”), 1-methoxy-2-propanol acetate (“PMA”), chloroform, a glycol, a glycol ether, or mixtures thereof. Other examples include ethoxy triglycol or methoxytriglycol.

Amine compounds can be used including primary, secondary, and tertiary amines, as well as amine compounds with two or more amino groups. They can, for example, neutralize the acid. Some examples of amines that can be used for neutralization of the acid include: hexadecyltrimethylammonium hydroxide [CH₃(CH₂)₁₅(CH₃)₃N⁺OH⁻], n-tetrabutylammonium hydroxide [(n-C₄H₉)₄NOH], tetraethylammonium hydroxide [(C₂H₅)₄NOH], tetramethylammonium hydroxide [(CH₃)₄NOH], tetrakis(decyl)ammonium hydroxide [(n-C₁₀H₂₁)₄NOH], dimethylethanol amine [(CH₃)₂NCH₂CH₂OH], triethanol amine N(CH₂CH₂OH)₃], N-tert-Butyldiethanol amine [t-C₄H₉N(CH₂CH₂OH)₂].

Other examples include alkylamines such as, for example, ethyl amine [C₂H₅NH₂], n-butylamine [C₄H₉NH₂], t-butyl amine [C₄H₉NH₂], n-hexy amine[C₆H₁₃NH₂], n-decylamine[C₁₀H₂₁NH₂], diethylamine [(C₂H₅)₂NH], di(n-propylamine) [(n-C₃H₉)₂NH], di(iso-propyl amine) [(i-C₃H₉)₂NH], trimethyl amine [(CH₃)₃N], triethylamine [(C₂H₅)₃N], tri(n-butylamine), tetramethyl ethylenediamine [(CH₃)₂NCH₂CH₂N(CH₃)₂], dimethyl ethylenediamine [CH₃ NHCH₂CH₂NHCH₃], ethylenediamine [H₂NCH₂CH₂NH₂], bis(hexamethylene)triamine [H₂N(CH₂)₆NH(CH₂)₆NH₂], N,N′,N″-Trimethylbis(hexamethylene)triamine [CH₃HN(CH₂)₆NH(CH₂)₆NHCH₃].

In addition, primary, secondary and tertiary alchohols, such as methanol, ethanol, propanol (n- and i-), butanol (n-, i-, t-), pentanol can be used.

In addition, other examples include homologous series of ethylene glycol and propylene glycol, glycerol and its ethers, ethylene/propylene glycol monoethers (cellosolves, ethylene glycol monoethers, e.g., methyl cellosolve, ethyl cellosolve, butyl cellosolve, hexyl cellosolve, (carbitols, these are ethylene glycol monoethers, e.g., methyl cellosolve, ethyl cellosolve, butyl cellosolve, hexyl cellosolve (see, http://www.dow.com/oxysolvents/prod/index.htm for more examples). The cellosolve and carbitols can work effectively in conjunction with other polar solvents such as NMP, DMF, DMAc, DMSO, pyridine, ethylene/propylene glycol and its higher homologs, glycerol, and the like.

Other examples include formates and acetates of above ethers.

Other examples include glycol ethers (e.g. cellosolve, butyl cellosolve, carbitol, butyl carbitol, and the like) and glycols (e.g. ethylene glycol, diethylene glycol, propylene glycol, propane diols, butanediols and the like).

Water can be also present in various quantities including, for example, use as a minority solvent 0.1 wt. % to 49 wt. %, or 0.5 wt. % to 40 wt. %, or 1 wt. % to 33 wt. %, or 1 wt. % to 5 wt. %.

The boiling point of the solvent can be adapted to be functionally useful to remove water and avoid decomposition of the organic materials. For example, boiling point at 760 mm Hg can be, for example, 150° C. to 240° C., or 180° C. to 220° C.

Also, mixtures and combinations of solvents can be used. For example, combinations of above solvents can be used in varying proportions to improve one or more properties such as, for example, film formability, jettability for ink jet applications, as thixotropic solvents for printing techniques such as screen printing, gravure or slot-die coating, wettability of substrates.

Additionally, solvents can be used as the primary solvent or in smaller quantities as processing aids, resistivity modifiers, viscosity modifiers, surface tension modifiers, drying enhancers, and for tuning band gap.

### Removing Water/Solvent Exchange

Described herein are methods of dispersing sulfonated polythiophenes in non-aqueous solvents. Solvent exchange can be carried out, and the term “solvent exchange” is known in the art. See, for example, U.S. Pat. No. 6,852,250.

One embodiment of the present application provides a method comprising: i) providing at least one sulfonated polythiophene in an aqueous dispersion, ii) adding a non-aqueous solvent to the dispersion to provide a mixture, wherein the sulfonated polythiophene remains dispersed in the mixture, and iii) removing water from the mixture.

In some embodiments, the sulfonated polythiophene of step i) can comprise, for example, a sulfonated poly(3-(alkoxy)thiophene), a sulfonated poly(3-(methoxyethoxyethoxy)thiophene), a regioregular sulfonated poly(3-(alkoxy)thiophene), or a regioregular sulfonated poly(3-(methoxyethoxyethoxy)thiophene).

In some embodiments, the aqueous dispersion of step i) can comprise, for example, about 0.1 wt. % to about 20 wt. % of the sulfonated polythiophene, about 0.1 wt. % to about 8 wt. % of the sulfonated polythiophene, about 0.25 wt. % to about 4 wt. % of the sulfonated polythiophene, or about 0.5 wt. % to about 1 wt. % of the sulfonated polythiophene.

In some embodiments, the non-aqueous solvent of step ii) can comprise an aprotic solvent, which can comprise an organic or inorganic solvent. In some embodiments, the non-aqueous solvent can comprise solvents such as NMP, DMSO, DMF, THF, PMA, chloroform, or mixtures thereof. The non-aqueous solvent of step ii) can be added to the aqueous dispersion in an amount that is about, for example, 30 wt. % to about 140 wt. % of the aqueous dispersion, about 60 wt. % to about 130 wt. % of the aqueous dispersion, or about 80 wt. % to about 120 wt. % of the aqueous dispersion. The range can be, for example, about 30 wt. % to about 40 wt. %.

The water removal step iii) may be accomplished by a method known to one skilled in the art. For example, the water can be removed from the mixture by evaporation. The removal of water by evaporation can occur at pressures below atmospheric pressure. For example, evaporation can occur at pressures of at most about 500 mm Hg, at most about 100 mmHg, at most about 50 mmHg, at most about 25 mmHg, at most about 10 mmHg, at most about 5 mmHg, or at pressures below 5 mmHg. The pressure can be, for example, 5-10 mmHg (torr). The removal of water by evaporation can commonly occur at temperatures above ambient temperature due to heating of the mixture. For example, the mixture may be heated to at least about 30° C., at least about 40° C., at least about 50° C., at least about 60° C., at least about 70° C., at least about 80° C., at least about at least about 90°, or at least about 100° C. In some embodiments, it may be desirable to begin the evaporation with the mixture heated to a temperature, for example, at least about 30° C., at least about 40° C., at least about 50° C., at least about 60° C., at least about 70° C., at least about 80° C., or at least about at least about 90° C. and after some period of time, for example, at least about 30 minutes, at least about an hour, or at least about 2 hours, raise the temperature of the mixture by at least about 5° C., at least about 1° C.°, or at least about 15 C.°. The removal of water by evaporation can also occur due to both reduced pressure and heating of the mixture during step iii). Pressures and temperatures suitable for combination in embodiments of the present application are described above.

In one embodiment, temperature for water removal is kept to 80° C. or less, or 70° or less, or 60° C. or less.

After performing the method as described above, water in the sulfonated polythiophene in the aqueous dispersion from step i) can commonly be reduced by, for example, about 10% to 60%, or, for example, at least 60% by weight, at least 70% by weight, at least 80% by weight, at least 90% by weight, at least 95% by weight, at least 98% by weight, at least 99% by weight, or by more than 99% by weight.

In some embodiments of the present application, it may be desirable to perform a further step iv) in the method of the present application, where step iv) comprises repeating steps ii) and iii) of the method at least once. The non-aqueous solvent added in step iv) can be added to the mixture in an amount that is about 0.1 wt. % to about 100 wt. % of the mixture, about 1 wt. % to about 70 wt. % of the mixture, about 5 wt. % to about 50 wt. % of the mixture, about 10 wt. % to about 40 wt. % of the mixture, or about 15 wt. % to about 35 wt. % of the mixture.

After performing the method of the present application, including step iv) as described above, water in the sulfonated polythiophene in the aqueous dispersion from step i) can commonly be reduced by at least 70% by weight, at least 80% by weight, at least 90% by weight, at least 95% by weight, at least 98% by weight, at least 99% by weight, or by more than 99% by weight.

### Other Embodiments

In another embodiment, solvent exchange can be carried out by re-dispersing or re-dissolving the solid polymer in a non-aqueous solvent (for example N-methylpyrrolidinone).

In addition, the formulations also can comprise other protic solvents such as optionally substituted amines (1°, 2°, 3°), optionally substituted ammonium hydroxides, water, optionally substituted alcohols, glycols or glycerols, optionally substituted ketones.

In another embodiment, the solid sulfonated polythiophene can be obtained by freeze-drying of the polymer or by precipitating into an appropriate non-solvent. The sulfonated polythiophene can be prepared using sulfonating agents such as, for example, acetyl sulfate, pyridine-sulfur trioxide complex, concentrated sulfuric acid in non-aqueous solvents followed by precipitation into alcohols, for example.

In addition to this, the solubility or redispersibilty in the above mentioned solvents could also be controlled by tailoring the molecular weight and/or polydispersity index of the polythiophene and/or the sulfonic acid percentage in the polymer. Furthermore, the regio-regularity of the polymer can also be reduced to increase the solvent and sulfonated polymer interaction. Control of the above polymer characteristics (viz., molecular weight, polydispersity, sulfonation percentage) can help in controlling the film properties such as transparency, conductivity, mobility.

### Matrix Materials and Polymers

Matrix materials, including polymers, oligomers, and small molecule compounds, are known in the art including planarizing agents. The matrix material and polymer can be soluble in the solvent systems described herein. It can be an organic polymer. It can comprise a carbon backbone with organic side groups. Examples include polar aprotic polymers. Other examples include polyether ketones, polyether sulfones, polyimides, polyamides, polyesters, polysulfones, polyarylamides, polystyrenics, and polyacrylates, and the like including derivatives thereof. Hole transporting polymers and lower molecular weight compounds can be used including arylamine compounds.

In some embodiments, matrix material or polymer of the present application may not include polar functional groups, such as —OH or —SO₃H. Desirably, the matrix material or polymer may comprise, for example, N,N,N′,N′-tetraphenyl-4,4′-diaminobiphenyl (“TPD”), polyethersulfone (“PES”), N,N′-bis-(1-naphthyl)-N,N′-diphenyl-1,1′-biphenyl-4,4′-diamine (“NPB”), poly(2-vinyl naphthalene) (“P2VN”), poly(N-vinylcarbazole) (“PVK”), or mixtures thereof.

Commonly the matrix polymers described above can be dispersed in a non-aqueous solvent, such as, for example NMP, DMSO, DMF, THF, PMA, chloroform, or mixtures thereof, at a concentration of about 1 wt. % to about 10 wt. %, about 1.5 wt. % to about 8 wt. %, about 2 wt. % to about 6 wt. %, or about 2.5 wt. % to about 4.5 wt. %.

Examples of matrix polymers can be found in, for example, PCT publication WO 2006/086,480 published Aug. 17, 2006, as well as U.S. provisional applications 61/108,844 filed Oct. 27, 2008; 61/108,851 filed Oct. 27, 2008; and 61/115,877 filed Nov. 18, 2008, as well as U.S. regular application Ser. Nos. 12/395,327 filed Feb. 27, 2009; and 12/399,006 filed Mar. 5, 2009; and 12/422,159 filed Apr. 10, 2009. See also, PCT Publication WO 2008/073149 including matrix polymers, oligomers, materials, and components.

### HIL/HCL/HTL Composition: Inks and Coatings/Layers

Ink compositions can be formed, and solvent can be removed from these ink compositions to yield coatings and layers, fully or partially dried. Coated substrates can be provided including conducting and non-conducting substrates, and substrates comprising metals, glasses, polymers, composites, ceramics, and other solid materials.

For example, sulfonated polythiophenes, dispersed in a non-aqueous solvent by the methods described above, may be combined with the matrix polymers described above, to form a composition that can be used, for example, to fabricate layers such as, for example, a hole transport, a hole collection, or a hole injection layer (“HIL”) of an organic electronic devices such as an OLED or OPV. In particular, the sulfonated polythiophenes dispersed in a non-aqueous solvent can be added with stirring to a matrix polymer or mixture of matrix polymers, also dispersed in a non-aqueous solvent or mixture of non-aqueous solvents, to form, for example, an HIL composition.

For an ink composition, the conjugated polymer can comprise, for example, 0.5 wt. % to 40 wt. % of the ink composition.

For example, the sulfonated polythiophene can comprise about 0.4 wt. % to 99 wt. %, or 0.4 wt. % to 40 wt. %, or comprise about 1 wt. % to about 30 wt. % of solids in the composition, 5 wt. % to about 25 wt. % of solids in the composition, or about 10 wt. % to about 20 wt. % of solids in the composition.

In an additional embodiment, the polymer can be freeze-dried to a dry solid and redispersed in a solvent system of choice.

### Applications

Materials prepared as described herein can be used in a variety of electronic devices including, for example, OLEDS, PLEDS, SMOLEDS, OFETs, transparent electrodes, electrochromic windows including active layers, hole extraction layers in OPVs, hole injection layers and hole transport layers in OLEDs.

Inks can be patterned and printed by methods known in the art including, for example, spin coating and ink jet printing.

Polymer can be crosslinked as appropriate for the application.

OLEDs are described in, for example, Organic Light-Emitting Materials and Devices, Ed. Li and Meng, 2007.

OPVs are described in, for example, Organic Photovoltaics, Mechanisms, Materials, and Devices, Ed. Sun and Sarciftci, 2005.

Other applications include, for example, metal-metal oxide capacitors, polymer-polymer capacitors, seed-layers for printed circuitry (e.g., wherein metals are deposited electrochemically on printed lines of the conducting polymer).

### WORKING EXAMPLES

Further description is also provided by way of the following non-limiting working examples.

### Working Example 1

25 g of 0.74 wt. % aqueous sulfonated poly(3-(methoxyethoxyethoxy)thiophene-2,5-diyl) (“P3MEET-S”) were placed in a 100 mL round-bottom flask to which 25 g of anhydrous N-methyl-2-pyrrolidone (“NMP”) were added. Approximately 25 g of solvent were evaporated under reduced pressure in a rotary evaporator at 60° C., followed by addition of another 10 g of NMP to the round-bottom flask. Further evaporation under reduced pressure at 60° C. resulted in 34.14 g of 0.54 wt. % P3MEET-S dispersion in NMP.

### Working Example 2

10.125 g of a 2.00 wt. % N,N,N′,N′-tetraphenyl-4,4′-diaminobiphenyl (“TPD”) in NMP stock solution were placed in a vessel, and an additional 0.708 g of anhydrous NMP was added to the vessel. While stirring the TPD solution vigorously, 4.157 g of 0.54 wt. % P3MEET-S dispersion in NMP were added. No precipitation was observed.

### Working Example 3

7.788 g of a 2.00 wt. % TPD in NMP stock solution were placed in a vessel, and an additional 0.001 g of anhydrous NMP was added to the vessel. While stirring the TPD solution vigorously, 7.211 g of 0.54 wt. % P3MEET-S dispersion in NMP were added.

### Working Example 4

119.79 g of 0.74 wt. % aqueous P3MEET-S were placed in a 500 mL round-bottom flask to which 100.39 g of NMP were added. Solvent was evaporated under reduced pressure at 60° C. for one hour, followed by further evaporation under reduced pressure at 70° C. for 15 minutes. The resulting solution was a 0.65 wt. % P3MEET-S dispersion in NMP.

### Working Examples 5-9

The formulations used for each Working Example 5-9 are listed in Table 1 below. The procedure for each Working Example 5-9 was as follows: Quantities of 3.5 wt. % polyethersulfone (“PES”) in NMP stock solution and/or 3.5 wt. % N,N′-bis-(1-naphthyl)-N,N′-diphenyl-1,1′-biphenyl-4,4′-diamine (“NPB”) were placed in a vessel to which an additional 1.582 g of anhydrous NMP were added. While stirring the PES/NPB solution vigorously, 13.846 g of 0.65 wt. % P3MEET-S dispersion in NMP were added. Precipitation was not observed.

TABLE 1

| Example | PES (g) | NPB (g) | NMP (g) | P3MEET-S (g) |
|---|---|---|---|---|
| 5 | 0.510 | 0.000 | 29.400 | 0.090 |
| 6 | 0.450 | 0.060 | 29.400 | 0.090 |
| 7 | 0.390 | 0.120 | 29.400 | 0.090 |
| 8 | 0.330 | 0.180 | 29.400 | 0.090 |
| 9 | 0.270 | 0.240 | 29.400 | 0.090 |

### Working Example 10

109.73 g of 0.74 wt. % aqueous P3MEET-S were placed in a 500 mL round-bottom flask to which 119.79 g of dimethyl sulfoxide (“DMSO”) were added. Solvent was evaporated under reduced pressure at 60° C. for about one hour, followed by further evaporation under reduced pressure at about 70-75° C. for 1.5 hours. The viscous liquid was transferred to a separate container. The round-bottom flask was rinsed with 13.63 g of DMSO and the rinse DMSO was also transferred to the container holding the viscous liquid. The resulting solution was a 0.62 wt. % P3MEET-S dispersion in DMSO. The material was filtered through a 2.7 micron glass filter without clogging or precipitation.

### Working Example 11

36 g of 0.74 wt. % aqueous P3MEET-S were placed in a 250 mL round-bottom flask to which 36 g of dimethylformamide (“DMF”) were added. Solvent was evaporated under reduced pressure (about 10 mmHg) at 55° C. until 37 g of solvent had been removed. 10 g of DMF were added to the round-bottom flask, followed by further evaporation under reduced pressure (about 10 mmHg) at 55° C. until 10 g of solvent was removed. Another 10 g of DMF were added to the round-bottom flask, followed by further evaporation under reduced pressure (about 10 mmHg) at 55° C. until 1 g of solvent was removed. The resulting dispersion was filtered through a glass fiber mesh in a 60 mL syringe to yield a 0.6 wt. % P3MEET-S dispersion in DMF.

### Working Example 12

189 g of 0.74 wt. % aqueous P3MEET-S were placed in a 1 L round-bottom flask to which 189 g of dimethylformamide (DMF) were added. Solvent was evaporated under reduced pressure (about 10 mmHg) at 55° C. until 218 g of solvent had been removed. 50 g of DMF in two lots of 20 and 30 g were added to the round-bottom flask, followed by further evaporation under reduced pressure (about 10 mmHg) at 55° C. until 10 g of solvent were removed. The resulting 200 g dispersion was diluted with 30 g of DMF to yield a 0.6 wt. % P3MEET-S dispersion in DMF. The dispersion was stirred for 15 minutes at room temperature.

### Working Examples 13-18

The formulations used for each Working Example 13-18 are listed in Table 2 below. The procedure for each Working Example 13-18 was as follows: 7.286 g of 3.5 wt. % of a matrix polymer, i.e., polyethersulfone (“PES”), poly(-vinyl naphthalene) (“P2VN”), or poly(N-vinylcarbazole) (“PVK”) in DMF, were placed in a vessel. With the exception of Example 18, an additional quantity of DMF and/or NMP was added to the vessel. While stirring the matrix polymer solution vigorously, 7.500 g of a 0.60 wt. % P3MEET-S dispersion in DMF were added. Precipitation was not observed.

TABLE 2

| | P2VN | | | DMF | NMP | P3MEET-S |
|---|---|---|---|---|---|---|
| Example | (g) | PES (g) | PVK (g) | (g) | (g) | (g) |
| 13 | 0.255 | 0.000 | 0.000 | 14.700 | 0.000 | 0.045 |
| 14 | 0.000 | 0.255 | 0.000 | 14.700 | 0.000 | 0.045 |
| 15 | 0.000 | 0.000 | 0.255 | 14.700 | 0.000 | 0.045 |
| 16 | 0.255 | 0.000 | 0.000 | 13.030 | 1.67 | 0.045 |
| 17 | 0.000 | 0.255 | 0.000 | 13.030 | 1.67 | 0.045 |
| 18 | 0.000 | 0.000 | 0.255 | 10.950 | 3.75 | 0.045 |

### Working Example 19

With an objective to increase ink viscosity, 148 g P3MEET-S solution (“solution A”) was mixed with 148 g ethoxy triglycol. The mixture was added into a flask attached to a rotary evaporator (Buchi Rotavapor R200). Solvent was removed at 70° C. for about an hour. The remaining solution comprising P3MEET-S was collected (147 g) to provide a solution having 0.882 wt. % solids. A substantially similar procedure was used with methoxy triglycol (1.333 wt. % solids). The “solution A” comprised 0.665% by wt. of P3MEET and 99.335% of water.

1. A method comprising:
i) providing at least one sulfonated polythiophene in at least one aqueous dispersion;
ii) adding at least one non-aqueous solvent to the dispersion to provide a mixture, wherein the sulfonated polythiophene remains dispersed in the mixture; and
iii) removing water from the mixture.

2. The method of claim 1, wherein the sulfonated polythiophene comprises a sulfonated regioregular polythiophene.

3. The method of claim 1, wherein the sulfonated polythiophene comprises a sulfonated regioregular polythiophene comprising alkyleneoxy substituent, polyether substituent, or combinations thereof.

4. The method of claim 1, wherein the aqueous dispersion comprises about 0.1 wt. % to about 8 wt. % of the sulfonated polythiophene.

5. The method of claim 1, wherein the non-aqueous solvent comprises methyl-2-pyrrolidone (“NMP”), dimethyl sulfoxide (“DMSO”), dimethylformamide (“DMF”), tetrahydrofuran (“THF”), 1-methoxy-2-propanol acetate (“PMA”), chloroform, a glycol, a glycol ether, or mixtures thereof.

6. The method of claim 1, wherein the non-aqueous solvent comprises methyl-2-pyrrolidone (“NMP”), dimethyl sulfoxide (“DMSO”), and dimethylformamide (“DMF”).

7. The method of claim 1, wherein the amount of non-aqueous solvent added to the aqueous dispersion is about 80 wt. % to about 120 wt. % of the aqueous dispersion.

8. The method of claim 1, wherein step iii) comprises removing water under reduced pressure.

9. The method of claim 1, wherein step iii) comprises removing water under a pressure of no more than about 100 mm Hg.

10. The method of claim 1, wherein step iii) comprises heating the mixture.

11. The method of claim 1, wherein step iii) comprises heating the mixture to at least about 40° C.

12. The method of claim 1, wherein step iii) comprises heating the mixture under reduced pressure.

13. The method of claim 1, wherein step iii) comprises heating the mixture to at least about 40° C. under a pressure of no more than about 100 mm Hg.

14. The method of claim 1, wherein step iii) comprises heating the mixture to a first temperature and then heating the mixture to a second temperature that is at least about 5 C.° higher than the first temperature.

15. The method of claim 1, wherein water in the aqueous dispersion of step i) is reduced by at least 80% by weight.

16. The method of claim 1, further comprising a step iv), wherein step iv) comprises repeating steps ii) and iii) at least once.

17. The method of claim 1, further comprising a step iv), wherein step iv) comprises repeating steps ii) and iii) at least once, and wherein water in the aqueous dispersion from step i) is reduced by at least 90% by weight.

18. The method of claim 1, further comprising a step iv), wherein step iv) comprises repeating steps ii) and iii) at least once, and wherein the amount of non-aqueous solvent added to the mixture when step ii) is repeated is about 5 wt. % to about 50 wt. % of the mixture.

19. The method of claim 1, further comprising a step iv), wherein step iv) comprises combining the mixture from step iii) with a matrix polymer.

20. The method of claim 1, further comprising steps iv) and v), wherein step iv) comprises repeating steps ii) and iii) at least once, and wherein step v) comprises combining the mixture from step iv) with a matrix polymer.

21. A method comprising:
i) providing at least one sulfonated regioregular polythiophene in an aqueous dispersion; and
ii) adding a non-aqueous solvent to the dispersion to provide a mixture, wherein the sulfonated regioregular polythiophene remains dispersed in the mixture;
iii) removing water from the mixture.

22. The method of claim 21, wherein the sulfonated regioregular polythiophene comprises a sulfonated polythiophene comprising alkyleneoxy or polyether substituent groups.

23. The method of claim 21, wherein the aqueous dispersion comprises about 0.1 wt. % to about 8 wt. % of the sulfonated regioregular polythiophene.

24. The method of claim 21, wherein the non-aqueous solvent comprises methyl-2-pyrrolidone (“NMP”), dimethyl sulfoxide (“DMSO”), dimethylformamide (“DMF”), tetrahydrofuran (“THF”), 1-methoxy-2-propanol acetate (“PMA”), chloroform, a glycol, glycol ether, or mixtures thereof.

25. The method of claim 21, wherein the amount of non-aqueous solvent added to the aqueous dispersion is about 80 wt. % to about 120 wt. % of the aqueous dispersion.

26. The method of claim 21, wherein step iii) comprises removing water under reduced pressure.

27. The method of claim 21, wherein step iii) comprises heating the mixture.

28. The method of claim 21, wherein water in the aqueous dispersion of step i) is reduced by at least 80% by weight.

29. The method of claim 21, further comprising a step iv), wherein step iv) comprises repeating steps ii) and iii) at least once.

30. The method of claim 21, further comprising a step iv), wherein step iv) comprises combining the mixture from step iii) with a matrix polymer.

31. A method comprising:
i) providing at least one sulfonated polythiophene in an aqueous dispersion;
ii) adding a non-aqueous solvent to the dispersion to provide a mixture, wherein the sulfonated polythiophene remains dispersed in the mixture; and
iii) exposing the mixture to vacuum, wherein the relative water content of the mixture increases with exposure to vacuum.

32. The method of claim 31, wherein the sulfonated polythiophene is not associated with a doping polymer.

33. The method of claim 31, wherein the aqueous dispersion does not comprise PEDOT or PEDOT:PSS.

34. The method of claim 31, wherein the method increases the viscosity of the dispersion of polythiophene.

35. The method of claim 31, wherein a matrix material is blended into the sulfonated polythiophene.

36. The method of claim 31, wherein a matrix polymer is blended into the sulfonated polythiophene which is soluble in the non-aqueous solvent.

37. The method of claim 31, wherein the water content increasing results from azeotropic removal of water.

38. The method of claim 31, wherein the non-aqueous solvent is a polar, aprotic solvent.

39. The method of claim 31, wherein the method is used to formulate an ink for a hole injection layer, hole collection, or hole transport layer.

40. The method of claim 31, wherein the sulfonated polythiophene is mixed with a hole transport material.

41. A composition prepared by the method comprising:
i) providing at least one sulfonated polythiophene in an aqueous dispersion;
ii) adding a non-aqueous solvent to the dispersion to provide a mixture, wherein the sulfonated polythiophene remains dispersed in the mixture;
iii) removing water from the mixture to provide a non-aqueous dispersion of the sulfonated polythiophene; and
iv) combining the non-aqueous dispersion with a matrix polymer to form the composition.

42. The method of claim 41, wherein the sulfonated polythiophene comprises a sulfonated poly(3-(alkoxy)thiophene).

43. The method of claim 41, wherein the sulfonated polythiophene comprises a sulfonated poly(3-(methoxyethoxyethoxy)thiophene).

44. The method of claim 41, wherein the aqueous dispersion comprises about 0.1 wt. % to about 8 wt. % of the sulfonated polythiophene.

45. The method of claim 41, wherein the non-aqueous solvent comprises methyl-2-pyrrolidone (“NMP”), dimethyl sulfoxide (“DMSO”), dimethylformamide (“DMF”), tetrahydrofuran (“THF”), 1-methoxy-2-propanol acetate (“PMA”), chloroform, or mixtures thereof.

46. The method of claim 41, wherein the non-aqueous solvent comprises methyl-2-pyrrolidone (“NMP”), dimethyl sulfoxide (“DMSO”), and dimethylformamide (“DMF”).

47. The method of claim 41, wherein the amount of non-aqueous solvent added to the aqueous dispersion is about 80 wt. % to about 120 wt. % of the aqueous dispersion.

48. A composition prepared by the method comprising:
i) providing at least one sulfonated regioregular polythiophene in an aqueous dispersion;
ii) adding a non-aqueous solvent to the dispersion to provide a mixture, wherein the sulfonated regioregular polythiophene remains dispersed in the mixture;
iii) removing water from the mixture to provide a non-aqueous dispersion of the sulfonated regioregular polythiophene; and
iv) combining the non-aqueous dispersion with a matrix polymer to form the composition.

49. A composition prepared by the method of claim 1, 21, or 31.
